(19) United States
(12) Patent Application Publication
(10) Pub. No.: US 2023/0036396 A1
(43) Pub. Date: Feb. 2, 2023

(54) SECONDARY BATTERY

(71) Applicant: SANYO Electric Co., Ltd., Kadoma-shi, Osaka (JP)

(72) Inventors: Takafumi Hosokawa, Hyogo (JP); Taiki Nonaka, Hyogo (JP)

(73) Assignee: SANYO Electric Co., Ltd., Kadoma-shi, Osaka (JP)

(21) Appl. No.: 17/788,085

(22) PCT Filed: Dec. 15, 2020
(86) PCT No.: PCT/JP2020/046641

§ 371 Date: Jun. 22, 2022

(30) Foreign Application Priority Data
Dec. 27, 2019 (JP) 2019-237669

(51) Int. Cl. H01M 50/489; H01M 50/451; H01M 50/46; H01M 50/466

(52) U.S. Cl. CPC H01M 50/489; H01M 50/451; H01M 50/461; H01M 50/466

(57) ABSTRACT

This secondary battery comprises an electrode body obtained by laminating positive electrodes and negative electrodes with a separator interposed therebetween. The separator includes a first layer and a second layer having lower thermal shrinkage than the first layer, and has a tubular section that is formed into a tube shape and constitutes the outermost surface of the electrode body. The separator is arranged such that, in the tubular section thereof, the first layer faces the inside and the second layer faces the outside.

### TECHNICAL FIELD

The present invention generally relates to a secondary battery.

### BACKGROUND ART

In recent years, there has been an increasing demand for secondary batteries in various fields. In particular, for their ability to provide high energy density, lithium ion secondary batteries using non-aqueous electrolyte are widely used for in-vehicle application, power storage application, various electronic devices, and the like. The secondary battery comprises an electrode assembly including a positive electrode, a negative electrode, and a separator. The electrode assembly has a structure in which the separator is interposed between the positive electrode and the negative electrode, thereby preventing contact between the positive electrode and the negative electrode. There are proposed numerous means for more surely preventing the occurrence of internal short circuit caused by contact between the positive electrode and the negative electrode.

For example, in PATENT LITERATURE 1, there is proposed a method in which an adhesive layer is provided on a surface of a separator and an electrode assembly is thermocompression bonded to bond the surface of the separator and a surface of an electrode, to prevent internal short circuit from occurring due to a stacking position shift between the positive electrode and the negative electrode. In PATENT LITERATURE 2, there is proposed a secondary battery comprising a separator in which a heat-resistant porous layer containing inorganic particles is formed on a surface of a substrate, to prevent internal short circuit from occurring due to a conductive foreign substance.

### CITATION LIST

### Patent Literature

PATENT LITERATURE 1: Japanese Unexamined Patent Application Publication No. 2018-56142

PATENT LITERATURE 2: Japanese Unexamined Patent Application Publication No. 2018-49758

### SUMMARY

In the outermost surfaces of the electrode assembly in which no facing electrodes exist, the electrodes are also covered by the separator to prevent the mixture layers of the electrodes from being exposed, but the end of the separator may be turned up, causing exposure of a part of the mixture layer. Once the electrode mixture layer in the outermost surface of the electrode assembly is exposed, the exposed portion may fall off to enter the electrode assembly, piercing the separator, which may cause micro-short circuit. In particular, when the electrode assembly is manufactured through the thermocompression bonding step using the separator including two or more layers having different thermal shrinkage rates, rising or turning up of the end of the separator is increased.

A secondary battery according to the present disclosure is a secondary battery comprising an electrode assembly in which a positive electrode and a negative electrode are stacked with a separator interposed therebetween, wherein the separator includes a first layer and a second layer having a thermal shrinkage rate smaller than that of the first layer, and has a tubular portion that is formed into a tubular shape to form outermost surfaces of the electrode assembly, and the separator is provided so that in the tubular portion, the first layer faces an inner side and the second layer faces an outer side.

The secondary battery according to the present disclosure makes it possible to prevent the mixture layer of the electrode from being exposed to the outermost surface of the electrode assembly due to turning up of the end of the separator. This can prevent internal short circuit from occurring due to fall-off of the electrode mixture layer.

### BRIEF DESCRIPTION OF DRAWING

FIG. 1 is a perspective view illustrating an appearance of a secondary battery, which is an example of embodiments.

FIG. 2 is a perspective view of an electrode assembly, which is an example of embodiments.

FIG. 3 is a sectional view of the electrode assembly, which is an example of embodiments.

FIG. 4A is a sectional view of an electrode assembly of Comparative Example 1.

FIG. 4B is a sectional view of an electrode assembly of Comparative Example 2.

### DESCRIPTION OF EMBODIMENTS

Hereinafter, an example of an embodiment of the present disclosure will be described with reference to the drawings. Note that it has been assumed from the outset that a plurality of embodiments and variants which are exemplified below can be selectively combined.

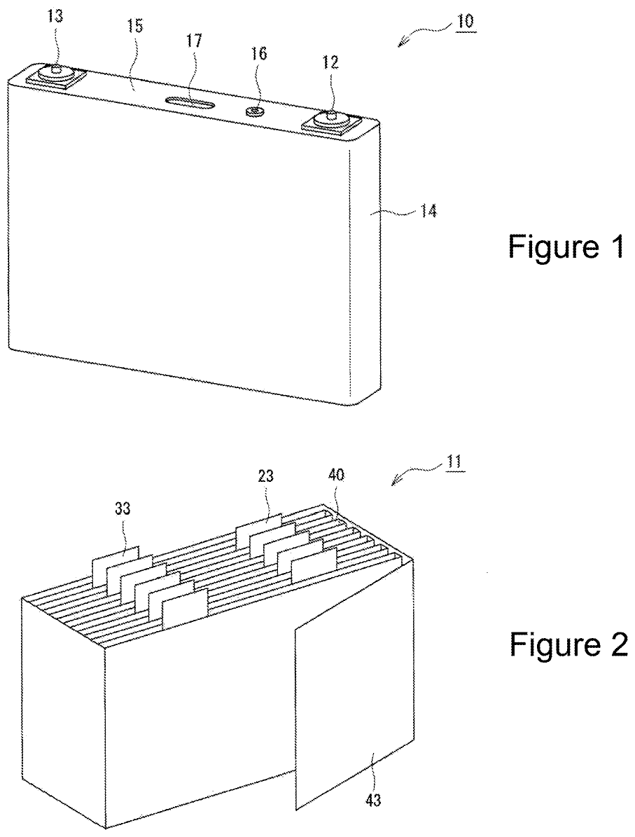

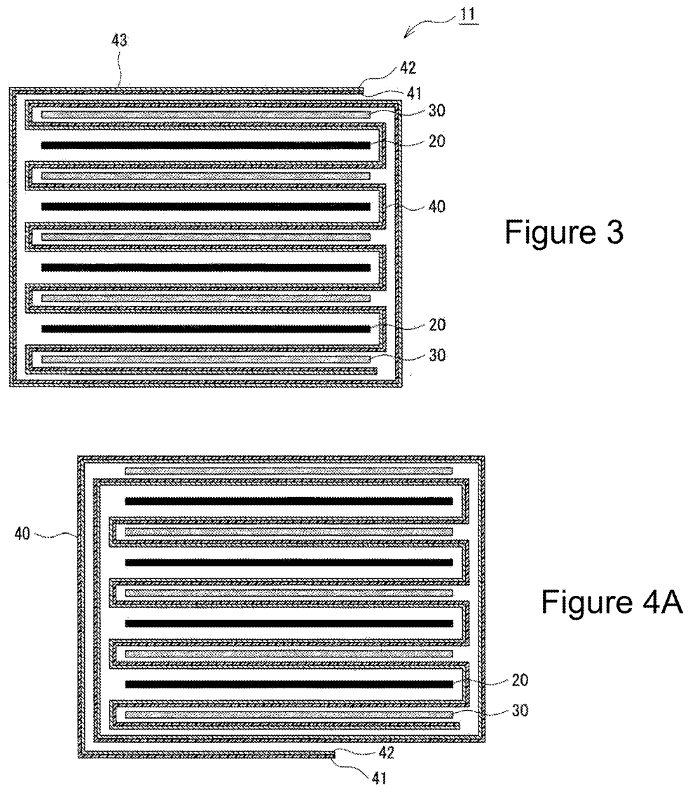

FIG. 1 is a perspective view illustrating an appearance of a secondary battery 10, which is an example of embodiments, and FIG. 2 is a perspective view of an electrode assembly 11 forming the secondary battery 10. FIG. 3 is a sectional view of the electrode assembly 11. The secondary battery 10 exemplified below is a so-called rectangular battery in which the electrode assembly 11 is housed in a rectangular exterior can 14, but an exterior body of the battery is not limited to the exterior can 14, and, for example, may be an exterior body formed of a laminate sheet including a metal layer and a resin layer. Also, in the following description, a stacked electrode assembly 11 is exemplified which is formed in a structure in which a plurality of positive electrodes and a plurality of negative electrodes are stacked with a separator interposed therebetween, but the electrode assembly may be a wound electrode assembly.

As illustrated in FIGS. 1 to 3, the secondary battery 10 comprises the electrode assembly 11 formed by stacking positive electrodes 20 and negative electrodes 30 with a separator 40 interposed therebetween, the bottomed rectangular tubular exterior can 14 configured to house the electrode assembly 11, and a sealing plate 15 configured to close an opening of the exterior can 14. The exterior can 14 is a flat, substantially rectangular parallelepiped metal container, which is open on one side in an axial direction, and the sealing plate 15 has an elongated rectangular shape. Each of the exterior can 14 and the sealing plate 15 is made of a metal material containing aluminum as a main component, for example.

In the following description, the height direction of the exterior can 14 is referred to as an “up and down direction” of the secondary battery 10 and each component, the sealing plate 15 side is referred to as “upper,” and the bottom portion side of the exterior can 14 is referred to as “lower,” for convenience of description. The direction along a longitudinal direction of the sealing plate 15 is referred to as a “lateral direction” of the secondary battery 10 and each component. In the electrode assembly 11, a portion except for a tubular portion 43 of the separator 40, which will be described later, may be referred to as an “electrode group”.

The secondary battery 10 comprises the electrode assembly 11 and an electrolyte housed in the exterior can 14. The electrolyte may be an aqueous electrolyte, and preferably be a non-aqueous electrolyte. The non-aqueous electrolyte contains a non-aqueous solvent, and an electrolyte salt dissolved in the non-aqueous solvent, for example. As the non-aqueous solvent, for example, esters, ethers, nitriles, amides, or a mixed solvent containing at least two of those mentioned above may be used. The non-aqueous solvent may also contain a halogen substitute in which at least one hydrogen atom of each of those solvents mentioned above is substituted by a halogen atom such as fluorine. As the electrolyte salt, for example, a lithium salt such as LiPF₆ is used.

The electrode assembly 11 includes a plurality of positive electrodes 20 and a plurality of negative electrodes 30, and has a structure in which the positive electrodes 20 and the negative electrodes 30 are alternately stacked one by one via the separator 40 (see FIG. 3). In general, in the electrode assembly 11, the number of negative electrodes 30 is greater than the number of positive electrodes 20 by one, so that the negative electrodes 30 are provided at both ends in the stacking direction of the electrode group. The separator 40 has the tubular portion 43 which is formed into a tubular shape to form outermost surfaces of the electrode assembly 11. That is, on the outermost surfaces of the electrode assembly 11, the separator 40 is tubularly wound one or more turns, and the negative electrodes 30 provided at both sides in the stacking direction of the electrode group are covered by the separator 40.

The electrode assembly 11 has a stacking structure in which one sheet of separator 40 folded in a zigzag shape is interposed between the positive electrodes 20 and the negative electrodes 30. Then, the tubular portion 43 is formed by such one sheet of separator 40. Note that the separator interposed between the positive electrodes and the negative electrodes may be separated from the separator forming the outermost surfaces of the electrode assembly, and therefore, the electrode assembly may include a plurality of separators, each of which is provided between the positive electrode and the negative electrode, and one sheet of separator forming a tubular portion.

The electrode assembly 11 has a plurality of positive electrode tabs 23 and a plurality of negative electrode tabs 33, the tabs extending toward the sealing plate 15 side. For example, the positive electrode tab 23 is a part of a core of the positive electrode 20 which is formed to project upward, and similarly, the negative electrode tab 33 is a part of a core of the negative electrode 30 which is formed to project upward. The positive electrodes 20 and the negative electrodes 30 are stacked with the separator 40 interposed therebetween so that the positive electrode tabs 23 and the negative electrode tabs 33 are oriented toward the same direction, the positive electrode tabs 23 are located on one end side in the lateral direction of the electrode assembly 11 and the negative electrode tabs 33 are located on the other end side in the lateral direction of the electrode assembly 11.

A positive electrode terminal 12 and a negative electrode terminal 13 are attached to the sealing plate 15. For example, the positive electrode tabs 23 are electrically connected to the positive electrode terminal 12 via a positive electrode current collector (not illustrated), and the negative electrode tabs 33 are electrically connected to the negative electrode terminal 13 via a negative electrode current collector (not illustrated).

The positive electrode terminal 12 and the negative electrode terminal 13 are external connection terminals to be electrically connected to another secondary battery 10, electronic device, or the like, and are attached to the sealing plate 15 via an insulating member. The sealing plate 15 is generally provided with a liquid injection portion 16 for injecting the electrolytic solution, and a gas discharge vent 17 for opening a vent in the event of a battery malfunction to discharge gas.

Hereinafter, the positive electrode 20, the negative electrode 30, and the separator 40 forming the electrode assembly 11 will be described in detail, with particular reference to the layer structure and arrangement of the separator 40.

### Positive Electrode

The positive electrode 20 has a positive electrode core and a positive electrode mixture layer formed on a surface of the positive electrode core. Examples of the positive electrode core include a foil of a metal that is stable in a potential range of the positive electrode 20, such as aluminum or an aluminum alloy, and a film in which such a metal is provided on the surface layer. The positive electrode mixture layer contains a positive electrode active material, a conductive agent, and a binder, and is preferably provided on each side of the positive electrode core. The positive electrode 20 can be fabricated by, for example, applying a positive electrode mixture slurry containing a positive electrode active material, a conductive agent, a binder, and the like on the positive electrode core, drying the resulting coating film, and then compressing it to form a positive electrode mixture layer on each side of the positive electrode core.

A lithium transition metal composite oxide is used as the positive electrode active material. Examples of a metal element contained in the lithium transition metal composite oxide include Ni, Co, Mn, Al, B, Mg, Ti, V, Cr, Fe, Cu, Zn, Ga, Sr, Zr, Nb, In, Sn, Ta, and W. In particular, at least one of Ni, Co, and Mn is preferably contained. Suitable examples of the composite oxide include a lithium transition metal composite oxide containing Ni, Co, and Mn, and a lithium transition metal composite oxide containing Ni, Co, and Al.

Examples of the conductive agent contained in the positive electrode mixture layer can include carbon materials such as carbon black, acetylene black, Ketjenblack, and graphite. Examples of the binder contained in the positive electrode mixture layer can include fluororesin such as polytetrafluoroethylene (PTFE) and polyvinylidene fluoride (PVdF), polyacrylonitrile (PAN), polyimide resins, acrylic resins, and polyolefin resins. Also, these resins may be used in combination with a cellulose derivative such as carboxymethyl cellulose (CMC) or a salt thereof, a polyethylene oxide (PEO), or the like.

### Negative Electrode

The negative electrode 30 has a negative electrode core and a negative electrode mixture layer formed on a surface of the negative electrode core. Examples of the negative electrode core include a foil of a metal that is stable in a potential range of the negative electrode 30, such as copper, and a film in which such a metal is provided on the surface layer. The negative electrode mixture layer contains a negative electrode active material and a binder, and is preferably formed on each side of the negative electrode core. The negative electrode 30 can be fabricated by, for example, applying a negative electrode mixture slurry containing a negative electrode active material, a binder, and the like on each surface of the negative electrode core, drying the resulting coating film, and then compressing it to form a negative electrode mixture layer on each side of the negative electrode core.

The negative electrode mixture layer contains, for example, a carbon-based active material that reversibly occludes and releases lithium ions as the negative electrode active material. A preferable carbon-based active material is graphite including natural graphite such as flake graphite, massive graphite, and earthy graphite, and artificial graphite such as massive artificial graphite (MAG) and graphitized mesophase carbon microbeads (MCMB). As the negative electrode active material, an Si-based active material that is comprised of at least one of Si and an Si-containing compound may be used, and a carbon-based active material and an Si-based active material may be used in combination.

As the binder contained in the negative electrode mixture layer, a fluororesin, PAN, a polyimide, an acrylic resin, and a polyolefin, or the like may be used in the same manner as in the case of the positive electrode 20, and a styrene-butadiene rubber (SBR) is preferably used. Preferably, the negative electrode mixture layer may further contain CMC or a salt thereof, polyacrylic acid (PAA) or a salt thereof, polyvinyl alcohol (PVA), or the like. In particular, SBR may be preferably used in combination with CMC or a salt thereof, or PAA or a salt thereof.

### Separator

A porous sheet having ion permeability and insulating properties is used as the separator 40. The separator 40 includes a first layer and a second layer having a thermal shrinkage rate smaller than that of the first layer. In the present embodiment, the first layer is a porous resin layer, and the second layer is a porous heat resistant layer containing inorganic particles. Note that each of the first and second layers may be a resin layer, the separator may have a third layer. The second layer may be a resin layer having high heat resistance that is made of a resin having a higher melting point or softening point than that of a resin forming the first resin layer, such as an aramid resin, a polyimide, or a polyamid-imide.

As illustrated in FIG. 3, the separator 40 includes a porous resin substrate 41 (first layer), and a porous heat resistant layer 42 (second layer) formed on one side of the resin substrate 41. Providing the heat resistant layer 42 makes it difficult to cause breakage of the separator 40 due to a conductive foreign substance, and can reduce shrinkage of the separator 40 when the temperature increases. The heat resistant layer 42 is preferably formed only on one side of the resin substrate 41 to increase the cost effectiveness while reducing an increase in thickness of the electrode assembly 11.

The resin substrate 41 independently serves as a separator. A porous film having ion permeability and insulating properties is used as the resin substrate 41. A thickness of the resin substrate 41 is, for example, 1 μm to 20 μm, and preferably 5 μm to 15 μm. Examples of a material for the resin substrate 41 include polyethylene, polypropylene, an ethylene-propylene copolymer, and an olefin resin such as a copolymer with ethylene, propylene, or another α-olefin. A melting point of the resin substrate 41 is generally 200° C. or lower.

The heat resistant layer 42 contains inorganic particles as main components. The heat resistant layer 42 preferably contains insulating inorganic particles, and a binder binding the particles to each other and binding the particles to the resin substrate 41. The heat resistant layer 42 has ion permeability and insulating properties as with the resin substrate 41. A thickness of the heat resistant layer 42 is, for example, 1μm to 10 μm, and preferably 1μm to 6 μm.

At least one selected from alumina, boehmite, silica, titania, and zirconia can be used as the inorganic particles, for example. In particular, alumina or boehmite is preferably used. The contained amount of the inorganic particles is preferably 85% by mass to 99.9% by mass and more preferably 90% by mass to 99.5% by mass with respect to the mass of the heat resistant layer 42.

The same resins as the binders contained in the positive electrode mixture layer and the negative electrode mixture layer, such as fluorocarbon resins including PVdF, and SBR can be used as the binder contained in the heat resistant layer 42.

The contained amount of the binder is preferably 0.1% by mass to 15% by mass and more preferably 0.5% by mass to 10% by mass with respect to the mass of the heat resistant layer 42. The heat resistant layer 42 is formed by, for example, applying slurry containing inorganic particles and a binder to one side of the resin substrate 41, and drying the resulting coating film.

For example, an adhesive layer to be bonded to a surface of the positive electrode 20 or the negative electrode 30 is formed on at least one surface of the separator 40. The adhesive layer may be formed on each side of the separator 40, and in this case, the structure of the adhesive layer may be different between one side and the other side. A thickness of the adhesive layer is, for example, 0.1 μm to 1 μm or 0.2 μm to 0.9 μm. The adhesive layer is formed by, for example, applying an emulsion adhesive in which the adhesive component is dispersed in water to the surface of the separator 40, and drying the resulting coating film. The adhesive layer may be formed in a dotted shape, for example.

The adhesive layer has no adhesive property at room temperature (25° C.), and preferably exhibits an adhesive property by heating. An example of the adhesive forming the adhesive layer is an adhesive made from an acrylic resin as a main component. The electrode assembly 11 is manufactured by, for example, stacking the negative electrode 30, the separator 40 with adhesive layers, the positive electrode 20, and the separator 40 with adhesive layers in this order, and subjecting the resulting laminate to a hot pressing step (thermocompression bonding step). Note that in the hot pressing step, the resin substrate 41 is heated, which may cause thermal shrinkage.

The separator 40 is preferably provided so that the heat resistant layer 42 faces the positive electrode 20 side. That is, the separator 40 is provided between the positive electrode 20 and the negative electrode 30 in the state in which the resin substrate 41 contacts the negative electrode 30 and the heat resistant layer 42 contacts the positive electrode 20. In this case, the oxidation deterioration of the resin substrate 41 of the separator 40 due to the positive electrode potential can be further reduced as compared with a configuration in which the resin substrate 41 faces the positive electrode 20 side. In the example illustrated in FIG. 3, the heat resistant layer 42 is provided on each side of all of the positive electrodes 20.

The separator 40 is folded in a zigzag shape and is interposed between the positive electrodes 20 and the negative electrodes 30, and is formed into a tubular shape to form outermost surfaces of the electrode assembly 11. The tubular portion 43 of the separator 40 forming the outermost surfaces of the electrode assembly 11 is formed by tubularly winding the separator 40 one or more turns along the side surfaces of the electrode group, and covers the entire side surfaces of the electrode group to prevent the side surfaces from being exposed to the outside. Here, the side surfaces of the electrode group refer to surfaces along the up and down direction of the electrode assembly 11, the surfaces including both end surfaces in the stacking direction of the electrode group (in the present embodiment, surfaces of the negative electrodes 30 provided at both ends in the stacking direction of the electrode group, which do not face the positive electrodes 20) and surfaces along the stacking direction of the electrode group.

The separator 40 is attached to cover the entirety of the mixture layers of the negative electrodes 30 located most outside in the stacking direction. That is, the tubular portion 43 is formed by tubularly winding the separator 40 around the side surfaces of the electrode group to prevent the mixture layers of the negative electrodes 30 from being exposed to the outermost surfaces of the electrode assembly 11. In the example illustrated in FIG. 3, the separator 40 is wound two turns around a part of the side surfaces of the electrode group to thereby form two layers of the separator 40. That is, a part of the tubular portion 43 is formed by the two layers of the separator 40, and a remaining part is formed by one layer of the separator 40.

The tubular portion 43 may be formed by winding the separator 40 three or more turns around the side surfaces of the electrode group, to be formed of three or more layers of separator 40, and the tubular portion 43 is preferably formed of one layer or two layers of separator 40. An increase in the number of layers of the separator 40 forming the tubular portion 43 makes it easier to prevent rising or turning up of the end of the separator 40, but for example, excess separator 40 absorbs the electrolytic solution, which causes the deterioration of the charge-discharge cycle characteristics.

The separator 40 is provided so that in the tubular portion 43, the first layer having a large thermal shrinkage rate faces the inner side of the electrode assembly 11, and the second layer having a thermal shrinkage rate smaller than that of the first layer faces the outer side of the electrode assembly 11. In the present embodiment, the separator 40 is provided so that the resin substrate 41 faces the inner side, and the heat resistant layer 42 faces the outer side. Here, the thermal shrinkage rate refers to the degree of shrinkage (length change) when the separator 40 is heated.

In the present embodiment, the heat resistant layer 42 of the separator 40 is provided on the outermost surface of the electrode assembly 11. The thermal shrinkage rate of the heat resistant layer 42 is smaller than the heat thermal shrinkage rate of the resin substrate 41, for example, at 110° C. (a heating temperature while applying a load to the electrode assembly, which will be described later). The separator 40 is provided with folded in a zigzag shape, between the positive electrodes 20 and the negative electrodes 30 so that the heat resistant layer 42 faces the positive electrode 20 side, and is tubularly wound one or more turns while covering the side surfaces of the electrode group so that the tubular portion 43 is formed in which the resin substrate 41 faces the inner side and the heat resistant layer 42 faces the outer side.

It is assumed that the separator 40 thermally shrinks in the above-described hot pressing step in the same manner as in the case of the conventional separator. In the conventional separator, rising or turning up easily occurs at the end in the axial direction of the tubular portion due to thermal shrinkage, but the separator 40 can be used to prevent such rising or turning up, and highly prevent the mixture layer of the negative electrode 30 from being exposed to the outermost surface of the electrode assembly 11. In the separator 40, the heat resistant layer 42 that has a small thermal shrinkage rate or does not substantially shrink thermally is provided outside of the tubular portion 43, and therefore the heat resistant layer 42 functions as a rigid layer that maintains the shape of the separator 40, which prevents the end in the axial direction of the tubular portion 43 from being warped outward to cause turning up.

In addition, in the separator 40, the resin substrate 41 having a large thermal shrinkage rate is provided inside of the tubular portion 43, and therefore, for example, the resin substrate 41 thermally shrinks, whereby the end in the axial direction of the tubular portion 43 comes into close contact with the surface of the negative electrode 30 (the side surface of the electrode group). That can prevent rising of the end in the axial direction of the tubular portion 43. Note that the separator 40 may thermally shrink due to heat generation not only in the hot pressing step but also in using the secondary battery 10.

### EXAMPLES

Hereinafter, although the present disclosure will be further described in detail with reference to Examples, the present disclosure is not limited to the following Examples.

### Example 1

### Fabrication of Positive Electrode

As a positive electrode active material, a lithium nickel cobalt manganese composite oxide was used. The positive electrode active material, acetylene black, and polyvinylidene fluoride (PVdF) were mixed together at a solid component mass ratio of 97:2:1, so that a positive electrode mixture slurry was prepared using N-methyl-2-pyrrolidone (NMP) as a dispersion medium. Next, the positive electrode mixture slurry was applied onto both surfaces of the positive electrode core formed of an aluminum foil with a thickness of 13 μm except for a portion serving as the positive electrode tab, and the resulting coating films were dried and compressed, followed by cutting to a predetermined electrode size, thereby obtaining a positive electrode (76 mm×139 mm) having a positive electrode mixture layer (thickness: 62 μm for one side) formed on each of both surfaces of the positive electrode core. In addition, the positive electrode tab is formed in the positive electrode, the positive electrode tab having a width of 20 mm and being a part of the core formed to project upward.

### Fabrication of Negative Electrode

As a negative electrode active material, graphite was used. The negative electrode active material, carboxymethyl cellulose (CMC), and a styrene-butadiene rubber (SBR) were mixed together at a solid component mass ratio of 98:1:1, so that a negative electrode mixture slurry was prepared using water as a dispersion medium. Next, the negative electrode mixture slurry was applied onto both surfaces of the negative electrode core formed of a copper foil with a thickness of 8 μm except for a portion serving as the negative electrode tab, and the resulting coating films were dried and compressed, followed by cutting to a predetermined electrode size, thereby obtaining a negative electrode (78 mm×143 mm) having a negative electrode mixture layer (thickness: 76 μm for one side) formed on each of both surfaces of the negative electrode core. In addition, the negative electrode tab is formed in the negative electrode, the negative electrode tab having a width of 18 mm and being a part of the core formed to project upward.

### Fabrication of Separator

As a resin substrate 41, a porous substrate having a thickness of 12 μm and made of polyethylene was used, and a slurry containing alumina particles and PVdF was applied to one side of the substrate to form a heat resistant layer 42 having a thickness of 4 μm, thereby obtaining a separator (width: 81 mm) having a two-layer structure including the porous resin substrate 41 and the porous heat resistant layer 42. The adhesive containing an acrylic resin as a main component was applied in a dot shape on each of both sides of the separator, to form an adhesive layer.

### Preparation of Non-Aqueous Electrolytic Solution

Ethylene carbonate (EC) and methyl ethyl carbonate (EMC), and dimethyl carbonate (DMC) were mixed together in a volume ratio (25° C., 1 atm) of 3:3:4. To the mixed solvent, LiPF₆ was dissolved with a concentration of 1 mol/L, and a non-aqueous electrolytic solution was thus prepared.

### Fabrication of Electrode Assembly

An electrode group was fabricated by alternately stacking the 35 positive electrodes and the 36 negative electrodes one by one via the separator folded in a zigzag shape, and the separator was wound around the side surfaces of the electrode group and the winding finish end of the separator was fixed by the tape, thereby obtaining a laminate (electrode assembly before thermocompression bonding) in which the entire side surfaces of the electrode group are covered by the separator. Note that the separator is provided so that the heat resistant layer 42 faces the positive electrode side in a portion between the positive electrode and the negative electrode. In the tubular portion of the separator that covers the side surfaces of the electrode group and is formed into a tubular shape, the resin substrate faces the inner side, and the heat resistance layer faces the outer side.

The laminate was heated using a hot plate of 110° C. for 43 seconds while applying a load of 20 kN to the laminate, thereby obtaining an electrode assembly.

### Fabrication of Secondary Battery

A plurality of positive electrode tabs extending from the electrode assembly were connected to a positive electrode terminal via a current collector, and similarly, a plurality of negative electrode tabs were connected to a negative electrode terminal via a current collector. The positive electrode terminal and the negative electrode terminal were fixed to the sealing plate via respective insulating members. The electrode assembly was housed in the bottomed rectangular tubular exterior can, and then the sealing plate was connected to an opening edge of the exterior can by laser welding. The non-aqueous electrolytic solution was injected from an injection vent of the sealing plate, and the injection vent was sealed by blind rivet nuts, thereby obtaining a non-aqueous electrolyte secondary battery having external dimensions of 148 mm wide×91 mm high×26.5 mm thick.

### Comparative Example 1

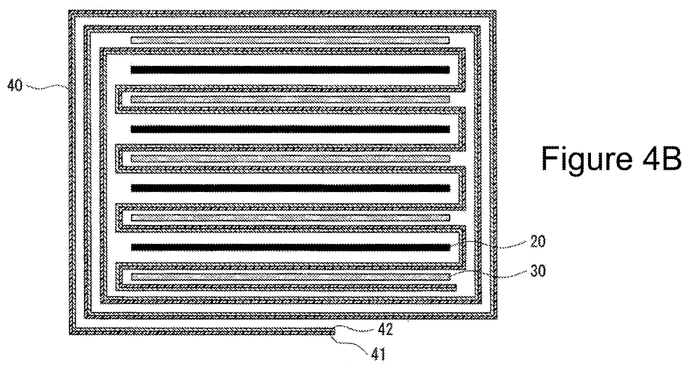

An electrode assembly and a secondary battery were obtained in the same manner as in Example 1, except that as illustrated in FIG. 4A, in the tubular portion of the separator 40 forming the outermost surfaces of the electrode assembly, the separator 40 was wound around the side surfaces of the electrode group so that the resin substrate 41 faced the outer side of the electrode assembly and the heat resistant layer 42 faced the inner side of the electrode assembly.

### Comparative Example 2

An electrode assembly and a secondary battery were obtained in the same manner as in Comparative Example 1, except that as illustrated in FIG. 4B, the separator 40 was wound one more turn than the number of turns in the electrode assembly of Comparative Example 1, around the side surfaces of the electrode group.

The electrode assemblies of Examples and Comparative Example were tested by the methods described below to evaluate rising or turning up of 90° or more of the separator and exposure of the negative electrode mixture layer in the outermost surface of the electrode assembly. The evaluation results are shown in Table 1. Note that the used amount of separator shown in Table 1 refers to a mass ratio of the separator with respect to each electrode assembly based on the mass (1.00) of the separator in the electrode assembly of Example 1.

### Evaluation of Rising or Turning Up of 90° or More of Separator and Exposure of Negative Electrode Mixture Layer

Each electrode assembly of Examples and Comparative Example was placed on a desk to direct a plane located at one end in the longitudinal direction of the separator downward, there was observed the end in the axial direction of the tubular portion of the separator forming the outermost surfaces of the electrode assembly, to determine whether rising or turning up of 90° or more (outward warp) of the separator occurred and whether the negative electrode mixture layer was exposed to the outermost surface of the electrode assembly.

TABLE 1

| | | | Exposure of | |
|---|---|---|---|---|
| | | | Negative | |
| | | Turning Up of | Electrode | Used Amount |
| | Rising | 90° or More | Mixture Layer | of Separator |
| Example 1 | No | No | No | 1.00 |
| Comparative | Yes | Yes | Yes | 1.00 |
| Example 1 | | | | |
| Comparative | Yes | Yes | No | 1.03 |
| Example 2 | | | | |

As shown in Table 1, in the electrode assembly of Example 1, it was found that rising did not occur at the end of the separator, and therefore the negative electrode mixture layer was not exposed to the outermost surface of the electrode assembly. On the other hand, in the electrode assembly of Comparative Example 1 in which the heat resistant layer of the separator faced the inner side, turning up of 90° or more occurred at the end of the separator, and therefore the negative electrode mixture layer was exposed to the outermost surface of the electrode assembly. In the electrode assembly of Comparative Example 2 in which the separator was wound one more turn than the number of turns in the electrode assembly of Comparative Example 1, since the negative electrode mixture layer was covered by two layers of the separator, rising or turning up of 90° or more causing exposure of the negative electrode mixture layer did not occur at the end of the separator. However, in the electrode assembly of Comparative Example 2, it was found that a large used amount of the separator tended to cause the relative decrease in an electrolytic solution amount held in a portion of the separator interposed between the positive and negative electrodes and the deterioration of the charge-discharge cycle characteristics.

### REFERENCE SIGNS LIST

10 Secondary battery

11 Electrode assembly

12 Positive electrode terminal

13 Negative electrode terminal

14 Exterior can

15 Sealing plate

16 Liquid injection portion

17 Gas discharge vent

20 Positive electrode

23 Positive electrode tab

30 Negative electrode

33 Negative electrode tab

40 Separator

41 Resin substrate

42 Heat resistant layer

43 Tubular portion

1. A secondary battery, comprising: an electrode assembly in which a positive electrode and a negative electrode are stacked with a separator interposed therebetween,
wherein the separator includes a first layer and a second layer having a thermal shrinkage rate smaller than that of the first layer, and has a tubular portion that is formed into a tubular shape to form outermost surfaces of the electrode assembly, and
the separator is provided so that in the tubular portion, the first layer faces an inner side and the second layer faces an outer side.

2. The secondary battery according to claim 1, wherein
the first layer is a resin layer, and
the second layer is a heat resistant layer containing inorganic particles.

3. The secondary battery according to claim 2, wherein
the separator is provided so that the heat resistant layer faces the positive electrode.

4. The secondary battery according to claim 1, wherein
the electrode assembly includes a plurality of the positive electrodes and a plurality of the negative electrodes and has a stacking structure in which one sheet of the separator folded in a zigzag shape is interposed between the positive electrodes and the negative electrodes, and the tubular portion is formed by the one sheet of separator.

5. The secondary battery according to claim 1, wherein
an adhesive layer to be bonded to the positive electrode or the negative electrode is formed on at least one surface of the separator.
